(19) United States
(12) Patent Application Publication
(10) Pub. No.: US 2024/0187552 A1
(43) Pub. Date: Jun. 6, 2024

(54) Video Conference Image Correction

(71) Applicant: Zoom Video Communications, Inc., San Jose, CA (US)

(72) Inventors: Reed Hunter Allen, Medford, OR (US); Shane Paul Springer, Oregon City, OR (US)

(21) Appl. No.: 18/061,748

(22) Filed: Dec. 5, 2022

(51) Int. Cl. H04N 7/15; G06V 10/24; G06V 10/60; G06V 10/82; H04L 12/18; H04N 7/14

(52) U.S. Cl. CPC H04N 7/152; G06V 10/24; G06V 10/60; G06V 10/82; H04L 12/1822; H04N 7/147

(57) ABSTRACT

Image correction is performed to improve the quality of video content from a conference room device during a video conference. A server receives an image from a video feed of a conference room device connected to a video conference for transmission to a remote device connected to the video conference. The server identifies, using an improvement detection engine, a modification for the image. The server transmits the modification to an image correction engine configured to generate a corrected image based on the modification. The server receives the corrected image from the image correction engine. The server transmits the corrected image to the remote device for display.

### FIELD

This disclosure relates to image correction and image quality improvement, which may be implemented, for example, during a video conference implemented over a network.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for video conference image correction.

FIG. 5 is a data flow diagram of an example of a process for video conference image correction.

FIG. 6A is an example of an image generated during a video conference.

FIG. 6B is an example of a corrected image generated during a video conference.

FIG. 7 is a data flow diagram of an example of a process for conference room device configuration.

FIG. 8 is a flowchart of an example of a technique for video conference image correction.

FIG. 9 is a flowchart of an example of a technique for conference room device configuration.

### DETAILED DESCRIPTION

Video conference participants, such as users of video conferencing software of a unified communications as a service (UCaaS) software platform, may access video conferences from their personal computing devices or from devices within shared physical spaces, such as dedicated conference room devices. Dedicated conference room devices may provide a higher quality audiovisual input and output experience than most personal computing devices because of the sophisticated nature of their components (e.g., display units, speakers, microphones, and cameras). However, for the same reasons, such devices may also be difficult to configure. Oftentimes, conference room device configuration requires having a dedicated information technology professional or a contractor visit the site in order to optimally position or calibrate the microphone, the speaker, the camera, and/or the display unit. A misconfigured conference room device (e.g., a device having a tilted camera or a camera pointed at a lamp or reflection of light) may be difficult to reconfigure, as the dedicated information technology professional or the contractor may have limited availability. While it may in some cases be difficult or infeasible to resolve such a misconfiguration, it may be possible to modify images for output during a video conference to resolve quality issues resulting from the misconfiguration. Techniques for automatically improving the quality of images generated by dedicated conference room devices may thus be desirable.

Furthermore, during configuration of the conference room device, the use of technology to reduce the likelihood of configuration errors may be desirable. Typically, the configuration is completed by the information technology professional who might have limited time to dedicate to the configuration. If an error occurs and is not detected immediately (e.g., while the information technology professional is in the room), the information technology professional may have to come back to correct the error, wasting time and/or money on the process. Technology may assist with the configuration by, for example, automatically detecting that a component of the conference room device (e.g., a camera, a microphone, a speaker, or a display unit) is not properly configured or not optimally positioned, and prompting the information technology professional to reconfigure or reposition the component while they are still in the room and engaged in the configuration process.

Implementations of this disclosure address problems such as these by using a server configured to propose a modification for an image generated by a conference room device during a video conference. After the conference room device is configured, the server receives an image from a video feed of the conference room device. The image may be received for transmission to a remote device connected to the video conference and/or for testing the configuration of the conference room device. The server identifies, using an improvement detection engine, a modification representing a proposed improvement for the image. For example, the image may include a reflection of light on a glass table, and the modification may be to adjust the image to remove the reflection of light. The server transmits the modification to an image correction engine residing at the conference room device. The image correction engine generates a corrected image based on the modification, for example by placing a digital annotation (e.g., including the same imagery as other parts of the granite table) over the reflection of light. The corrected image is transmitted from the conference room device to the server and from the server to a remote device connected to the conference. Other images in the video feed from the conference room device may automatically receive the same correction prior to transmission to the remote device.

During the configuration of the conference room device, a configuration engine that resides at a server or at a conference room device receives an input indicating that the conference room device is being configured. The conference room device includes (or is connected to) at least one of a camera, a speaker, or a microphone. In some cases, the conference room device may be connected to at least one camera, at least one speaker, and at least one microphone. Alternatively, the conference room device may lack a camera, a speaker, or a microphone. For example, if the conference room device is designed for an audience member of a lecture, the conference room device may lack a microphone (as the audience member is not meant to speak). The configuration engine accesses a representation of a signal received via the conference room device. The signal may be, for example, an image captured via the camera or an audio signal output by the speaker and captured by the microphone. The configuration engine identifies a configuration of the conference room device based on the signal. For example, the configuration engine may determine that the camera is tilted and/or that the speaker or the microphone is not operating properly. The configuration engine determines an improvement to the configuration (e.g., a recommendation or instruction to tilt the camera 15 degrees upward or to confirm that the microphone and the speaker are receiving power, such as by them being plugged into an electric socket) and provides an output indicating the determined improvement. The output may be transmitted to a mobile device of an operator configuring the conference room device or may be displayed on a display unit of the conference room device. Alternatively, the output may be transmitted to an administrator of an account with which the conference room is associated, a host of a video conference in the conference room, or another party within the conference room or located in the same premises or campus as the conference room.

As used herein, the term “engine” may include software, hardware, or a combination of software and hardware to perform a set of operations. An engine may be implemented in software, hardware or a combination of software and hardware. An engine may reside in the cloud and may be assigned hardware resources on an ad hoc basis. Alternatively, an engine may be hard-wired into a processor of a special purpose computer. In another alternative, an engine may be implemented in software on a general-purpose computer.

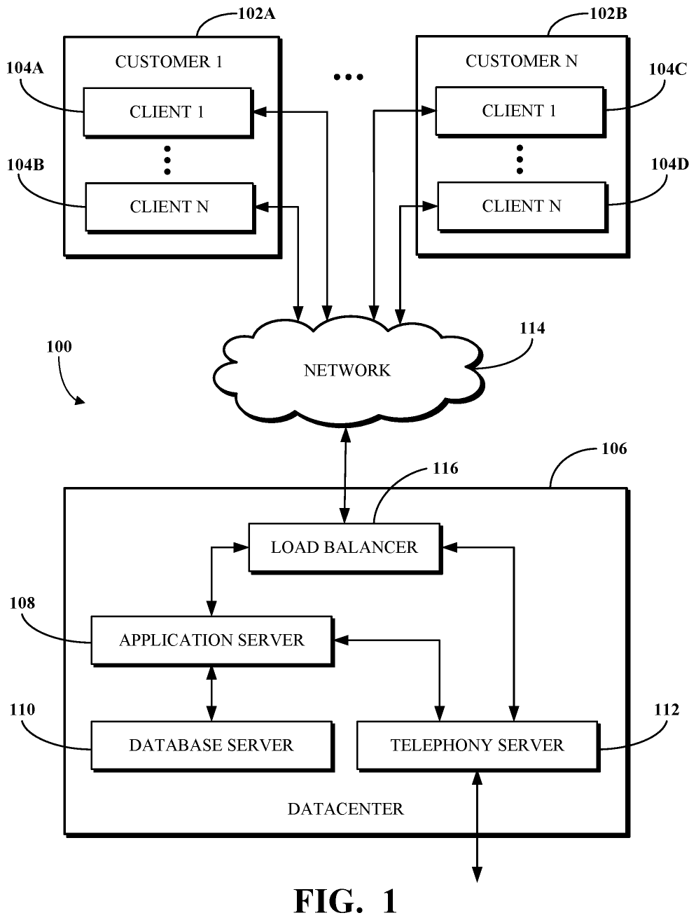

To describe some implementations in greater detail, reference is first made to examples of hardware and software structures used to implement video conference image correction. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

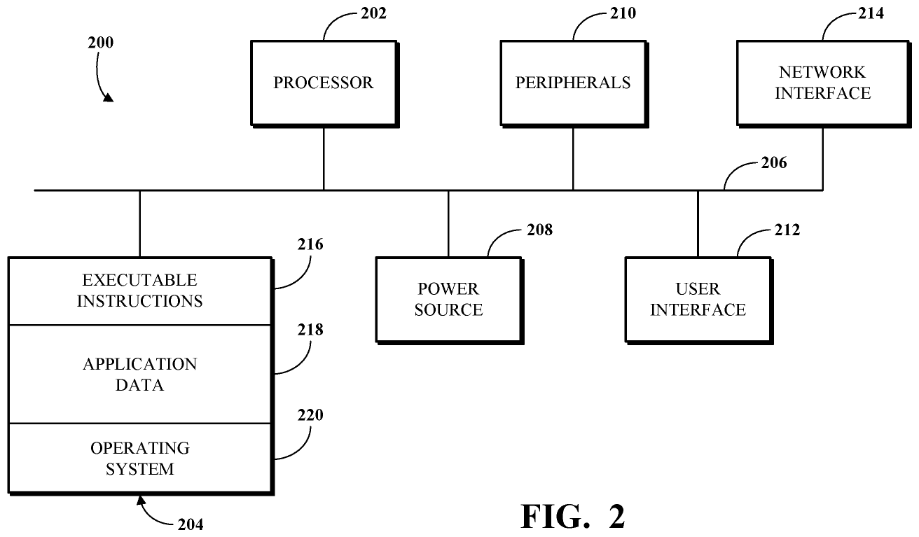

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

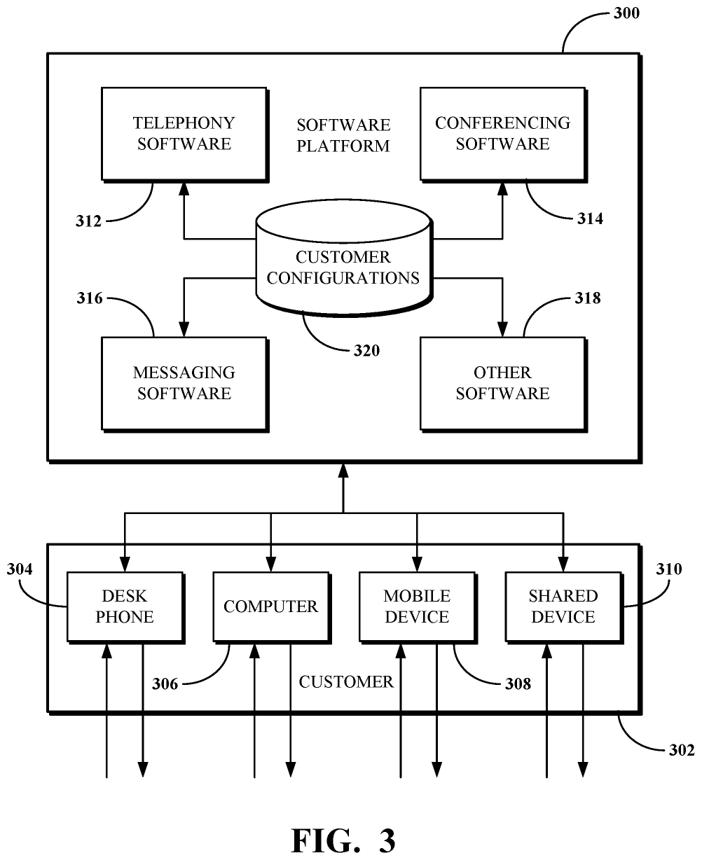

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include video conference image correction software.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

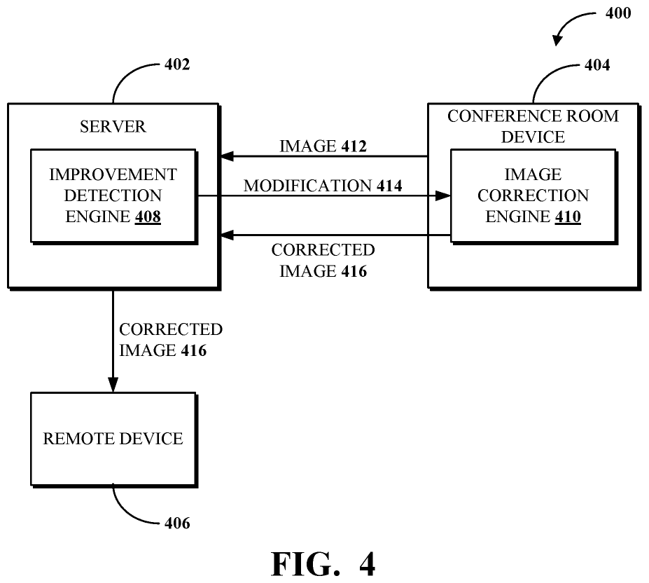

FIG. 4 is a block diagram of an example of a system 400 for video conference image correction. As shown, the system 400 includes a server 402, a conference room device 404, and a remote device 406. The server 402 may correspond to the application server 108. The conference room device 404 may correspond to one of the clients 104A-D (e.g., the shared device 310). The remote device 406 may correspond to one of the clients 104A-D (e.g., the computer 306 or the mobile device 308). The server 402 may communicate with the conference room device 404 and remote device 406 over a network (e.g., the network 114).

The conference room device 404 may in some cases be a special-purpose computer for video conferencing and may be housed in a conference room or other shared physical space of an office or a residence. The conference room device 404 may include (or be coupled with) at least one of a camera, a microphone, a speaker, or a display unit in addition to the components of the computing device 200. The camera and the microphone may be configured to record activity (e.g., visual or audio data) within the conference room. The speaker may be configured to play audio into the conference room. Alternatively, the conference room device 404 may be a general-purpose computer connected to video conferencing hardware, for example, a microphone, a speaker, a camera, or a display unit. The conference room device 404 is connected to a video conference (controlled by video conferencing software at the server 402) with the remote device 406. The remote device 406 may be at least one of a mobile phone, a tablet computer, a laptop computer, a desktop computer, or another conference room device.

As shown in FIG. 4, the server 402 includes an improvement detection engine 408. The improvement detection engine 408 is configured to detect flaws in images and to propose a modification to correct the flaws. For example, the improvement detection engine 408 may be configured to propose at least one of straightening a crooked image, increasing the brightness of a dark image, decreasing the brightness of a bright image, and/or obscuring a distracting or non-visually pleasing part of an image. The conference room device 404 includes an image correction engine 410 that actually performs the modification proposed by the improvement detection engine 408. The improvement detection engine 408 and/or the image correction engine 410 may be implemented using artificial intelligence techniques, for example, at least one of an artificial neural network (ANN), a convolutional neural network (CNN), a deep neural network (DNN), or a support vector machine (SVM).

In some cases, the server 402 includes more advanced or faster hardware than the conference room device 404. Thus, the server 402 may be used for detecting improvements, as this may be a computationally expensive task. However, the correction of the images may be repeated multiple times, for example, for each impacted frame in the video feed. This task may be performed at the conference room device 404 prior to display of the frames on the display unit of the conference room device 404 and/or prior to transmission of the frames in the video feed to the server 404 and the remote device 406.

As shown in FIG. 4, the server 402 receives an image 412 from a video feed of the conference room device 404 during the video conference. The video feed is for transmission to the remote device 406 (and, in some cases, other remote devices) connected to the video conference. The image 412 may be a frame of the video feed. The improvement detection engine 408 of the server 402 identifies a modification 414 for the image 412 and transmits the modification 414 to the image correction engine 410 of the conference room device 404. The modification 414 includes an instruction for making a change to the image 412 from the video feed. For example, the modification 414 may include an instruction to place a digital annotation over a bright light source (e.g., a lamp or window) depicted in the image 412. The image correction engine 410 generates a corrected image 416 by applying (e.g., using artificial intelligence techniques) the modification 414 to the image 412. The image correction engine 410 transmits the corrected image 416 to the server 402, and the server 402 forwards the corrected image 416 to the remote device 406 for display thereat. The conference room device 404 may also display the corrected image 416.

In some examples, the improvement detection engine 408 is implemented using an ANN. The ANN is trained using supervised learning, with the training data being a labeled (e.g., by a person) dataset of images (e.g., the image 412) and their associated improvements. The training data thus includes images on which modifications were made. The training data may also include images for which no modifications were proposed (e.g., by the person), as some images might not benefit from modifications.

In some examples, the image correction engine 410 is implemented using an ANN. The ANN is trained using supervised learning, with the training dataset being a labeled (e.g., by a person) dataset of images (e.g., the image 412), modifications (e.g., the modification 414) proposed by the improvement detection engine 408 (or by manual review of the images), and the resulting corrected images (e.g., the corrected image 416).

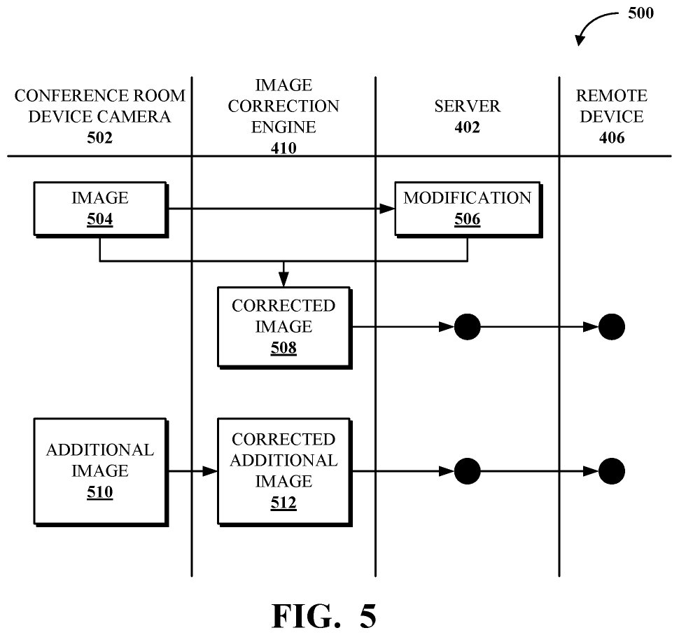

FIG. 5 is a data flow diagram of an example of a process 500 for video conference image correction. As shown, the process 500 is performed using a conference room device camera 502 (which may be a component of the conference room device 404 and/or connected to the conference room device 404), the image correction engine 410 of the conference room device 404, the server 402, and the remote device 406.

As shown in FIG. 5, the conference room device camera 502 captures an image 504 (e.g., corresponding to the image 412). The image 504 may be captured during a video conference as part of a video feed generated by the conference room device camera 502 for transmission to the remote device 406 connected to the video conference. The image 504 is transmitted from the conference room device camera 504 to the server 402. In response, the server 402 generates a proposed modification 506 for the image 504. The modification 506 may be generated using artificial intelligence technology, for example, an ANN of the improvement detection engine 408. The modification 506 may be, for example, rotating the image if the image is not straight, modifying a brightness level of the image to reach an optimal brightness level, modifying a color contrast of the image to reach an optimal color contrast, or placing a digital annotation to obscure a part of the image. The optimal brightness level or the optimal color contrast may be determined based on data regarding user preferences for brightness or color contrast. The part of the image that is obscured by the digital annotation may be recognized based on distracting imagery, reflections, or excessive brightness in the part, with the distracting imagery, reflections, or excessive brightness being recognized using artificial intelligence technology. After the modification 506 is generated, the server 402 transmits the modification 406 to the image correction engine 410.

The image correction engine 410 receives the modification 506 from the server 402 and the image 504 from the conference room device camera 502. The image correction engine 410 uses artificial intelligence technology (e.g., an ANN) to generate a corrected image 508 by applying the modification 506 to the image 504. The corrected image 508 is transmitted to the server 402, and the server 402 transmits the corrected image 508 to the remote device 406 connected to the video conference for display thereat.

At a later time, the conference room device camera 502 captures an additional image 510 for transmission to the remote device 406 in the video conference. The conference room device camera 502 provides the additional image 510 to the image correction engine 410. The image correction engine 410 generates a corrected additional image 512 by applying the modification 506 (received from the server 402 for the image 504) to the additional image 510. The modification 506 may be applied to the additional image 510 by the image correction engine 410 using a similar technique to the application of the modification 506 to the image 504.

As described in conjunction with FIGS. 4 and 5, the improvement detection engine 408 resides at the server 402, and the image correction engine 410 resides at the conference room device 404. In alternative implementations, however, the improvement detection engine 408 may reside at the conference room device 404 or at another server. The image correction engine 410 may reside at the server 402 or at another server. If the conference room device 404 is a thin client device with limited processing hardware and/or memory, then placing the image correction engine 410 at the server 402 or at another server may be advantageous to allow computationally intensive artificial intelligence algorithms to be executed at the image correction engine 410.

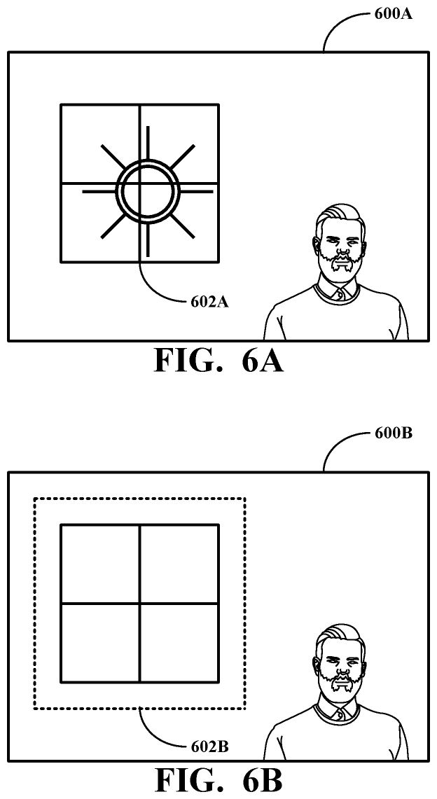

FIG. 6A is an example of an image 600A generated during a video conference by a conference room device camera (e.g., the conference room device camera 502). The image 600A may include visual data from within a conference room of an office or a residence. The image 600A may correspond to the image 412 or the image 504. As shown, the image 600A includes a window 602A with a bright light (from the sun) shining through it. The bright light from the window 602A is much brighter than the light in the rest of the image 600A and might be distracting for viewers of the image 600A.

FIG. 6B is an example of a corrected image 600B generated during a video conference. As shown, the image 600B includes the window 602B, but lacks the bright light shining through it. The image 600B is generated based on the image 600A.

In an example use case, during a video conference, the image 600A is captured by the conference room device camera 402 and transmitted from the conference room device 404 to the server 402. At the server 402, the improvement detection engine 408 determines that the window 602A is to be overlaid with a digital annotation and generates the modification 414 encoding the proposal to overlay the window 602A with the digital annotation. The digital annotation may correspond to a stored image corresponding to the window 602A (e.g., from a recording of a previous video conference to which the conference room device 404 was connected, when the light through the window was less bright, for example, due to the presence of clouds or due to the time of day being different). In some cases, the digital annotation might be stored outside the server 402 and might not be accessible to the server 402.

The modification 414 is transmitted to the image correction engine 410 at the conference room device 404. The image correction engine 410 accesses the image 600A and generates, based on the modification 414, a digital annotation (corresponding to the window 602B) to overlay the window 602A. For example, the digital annotation may be taken from other imagery of the window 602A/602B accessible to the conference room device 404. In one example, the digital annotation corresponds to a view of the window from a recording of a previous video conference to which the conference room device 404 was connected or an image of the window from a time when the conference room device 404 was being configured. The previous video conference may have occurred on a cloudy day or during a time when the sun was not brightly shining through the window 602B. It should be noted that imagery from the previous video conference might be used only if that imagery does not include human faces and if the host (or another person) associated with the conference approved such use.

In some implementations, when the window 602B is a digital annotation, the man shown at the right side of FIG. 6B may reposition himself to be in front of the window. In response, the man may be depicted in front of the digital annotation. As a result, a viewer viewing the image (e.g., at the remote device 406) might not be able to tell the difference between the window 602B being a digital annotation and being a real window in the viewing area of the camera of the conference room device 404.

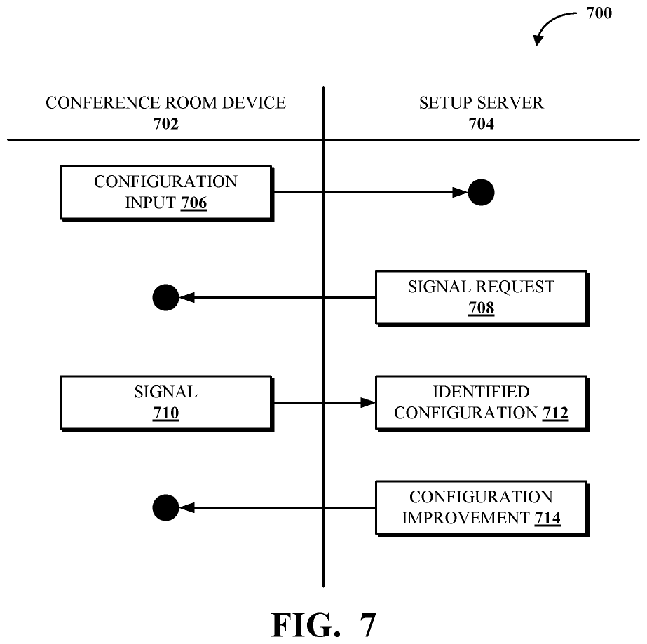

FIG. 7 is a data flow diagram of an example of a process 700 for conference room device configuration. As shown, the process 700 is performed using a conference room device 702 that is being configured and a setup server 704 that assists with the configuration. The conference room device 702 may correspond to the conference room device 404. The setup server 704 may correspond to the application server 108. The setup server 704 and the conference room device 702 may communicate with one another over a network. The configuration of the conference room device 702 may be an original configuration (e.g., when the conference room device is first installed) or a reconfiguration of the conference room device 702 if the conference room device 702 has been configured previously.

As shown, the conference room device 702 transmits a configuration input 706 to the setup server 704. The configuration input 706 is an indication that the conference room device 702 is being configured by an operator (e.g., a technician or administrator) and a request that the setup server 704 provide assistance with the configuration. The configuration input 706 may be transmitted from the conference room device 702 when the conference room device 702 is placed into a configuration mode by the operator. Alternatively, the configuration input 706 may be transmitted to the setup server 702 from a computing device of the operator when the operator begins the configuration of the conference room device 702. In that case, the configuration input 706 may include an indication of the location of the computing device of the operator or an identifier of the conference room device 702 that is being configured.

In response to receiving the configuration input 702, the setup server 704 transmits a signal request 708 to the conference room device 702. The signal request 708 may be a request for audio or visual data from the conference room device 702. In response to the signal request 708, the conference room device 702 generates a signal 710. The signal 710 may correspond to an image captured via a camera of the conference room device 702. Alternatively, the signal 710 may correspond to an audio input captured via a microphone of the conference room device 702. The audio input may correspond to a sound played via a speaker of the conference room device 702.

As illustrated in FIG. 7, the conference room device 702 transmits the signal 710 to the setup server 704. The setup server 704 computes an identified configuration 712 of the conference room device 702 based on the signal 710. For example, the identified configuration may correspond to an angle associated with the camera of the conference room device 702, a straightness of the image, a speaker quality, or a microphone quality. The setup server 704 computes a configuration improvement 714 based on the identified configuration 712. The configuration improvement 714 may correspond to a modification of a camera angle and/or a repositioning of the speaker or the microphone of the conference room device 702. As shown, the setup server 704 transmits the configuration improvement to the conference room device 702 for display to the operator via the conference room device 702. Alternatively, the configuration improvement 714 may be transmitted to a messaging address (e.g., an email address or a telephone number capable of receiving short messaging service (SMS) messages) of the operator. In some cases, if the conference room device 702 is capable of moving its own parts (e.g., capable of adjusting its own camera), the configuration improvement 714 may include instructions for moving the parts and may be transmitted to the conference room device 702. After the process 700 is completed, the conference room device 702 may be used to connect to video conferences, as described herein.

In an example use case, the operator configures a conference room device 702 from which a group of musicians is to play a virtual concert. Upon arrival, the operator places the conference room device 702 into a setup mode. In response to being placed into the setup mode, the conference room device 702 transmits a notification that it is in the setup mode to the setup server 704. The setup server 704 responds by sending a message to the conference room device 702 or to a device or a messaging address of the operator requesting that music be played in the conference room. The operator goes to the place in the conference room where the musicians are expected to stand and sings and plays the guitar from that place. The two microphones of the conference room device 702 record audio of the operator singing and playing the guitar, and the conference room device 702 then sends the audio recording to the setup server 704. Also, the camera of the conference room device 702 records imagery of the operator. After capturing at least the beginning of the audio recording (of the operator singing and playing the guitar), the setup server 704 determines that the two microphones are not optimally positioned and computes alternative positions for the microphones based on the audio recording. The alternative positions may be computed for optimal audio capture based on a wavelength or a frequency of the audio waves that were captured in the audio recording by the microphones, as well as based on a distance between the two microphones and a distance from a source of the audio to the microphones, as determined based on imagery captured by the camera of the conference room device 702. The setup server 704 generates an output image displaying proposed positions for the microphones within the imagery of the conference room that was taken while the operator was singing and transmits the output image to the conference room device 702 for display at a display unit thereof. Upon viewing the display of the output image, the operator moves the microphones to the appropriate places in the conference room. As a result, the virtual concert is recorded at a higher quality level, resulting in greater enjoyment by the audience.

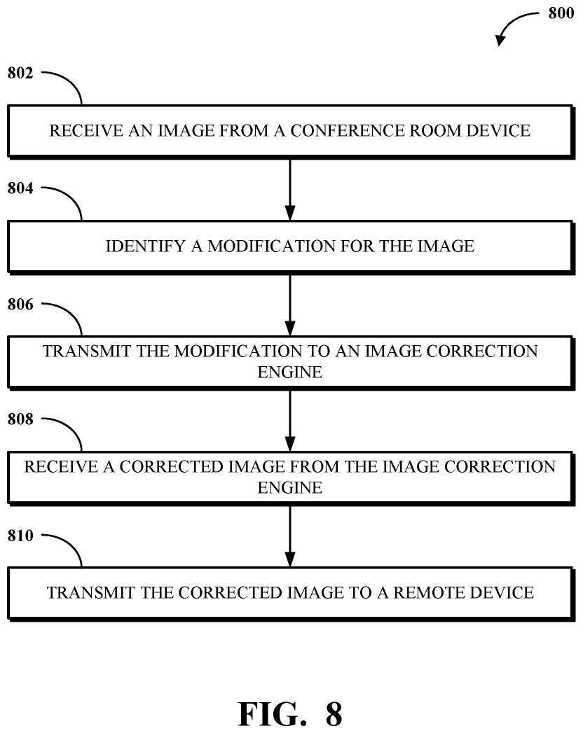

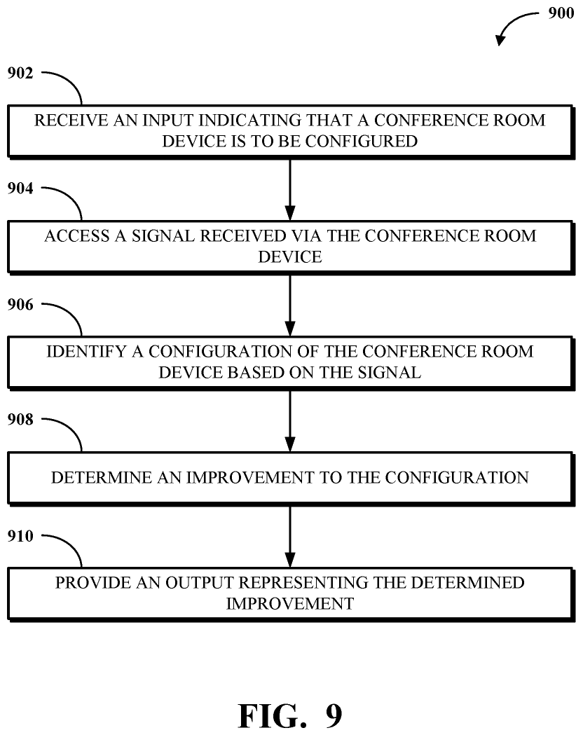

To further describe some implementations in greater detail, reference is next made to examples of techniques for video conference image correction and conference room device configuration. FIG. 8 is a flowchart of an example of a technique 800 for video conference image correction. FIG. 9 is a flowchart of an example of a technique 900 for conference room device configuration. The techniques 800 and/or 900 can be executed using computing devices, such as the systems, hardware, and software described with respect to FIGS. 1-7. The techniques 800 and/or 900 can be performed, for example, by executing a machine-readable program or other computer-executable instructions, such as routines, instructions, programs, or other code. The steps, or operations, of the techniques 800 and/or 900 or another technique, method, process, or algorithm described in connection with the implementations disclosed herein can be implemented directly in hardware, firmware, software executed by hardware, circuitry, or a combination thereof.

For simplicity of explanation, the techniques 800 and 900 are depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 8 illustrates the technique 800 for video conference image correction. The technique 800 may be implemented at a server, for example, the server 402, which includes the improvement detection engine 408.

At 802, the server receives an image from a conference room device (e.g. the conference room device 404). The image may be captured by a camera of the conference room device during a video conference. The image may be part of a video feed from the video conference and may be transmitted to the server for further transmission to remote devices (e.g., the remote device 406) connected to the conference.

At 804, the server identifies a modification for the image using an improvement detection engine (e.g., the improvement detection engine 408). The modification may include, for example, straightening the image, modifying a brightness level of the image, or placing a digital annotation to obscure a part of the image. Specifically, the modification is an instruction, a command, or a control signal (e.g., transmitted over a network) stating that the image is to be straightened, the brightness is to be modified, or a digital annotation is to be used to obscure the part of the image. In some cases, the server transmits, to an address (e.g., an email address or an address in an instant messaging service) associated with an administrator of the conference room device (e.g., an information technology administrator), a message including a representation of the modification. The administrator may then reconfigure the conference room device (or other items in the conference room) so that the modification is not necessary. For example, in the implementation described with respect to FIGS. 6A-B, the administrator may provide a curtain for the window 602A.

At 806, the server transmits the modification to an image correction engine configured to generate a corrected image based on the modification. The image correction engine may reside at the conference room device or at another server capable of communicating with the conference room device. The image correction engine generates a corrected image by applying the modification to the image.

At 808, the server receives a corrected image from the image correction engine. The corrected image is transmitted to the server for forwarding, via the video conference, to the remote device and, in some cases, other remote devices connected to the video conference. In some cases, the server transmits, to the conference room device, a prompt for approval of the corrected image. The conference room device may then present the corrected image and user interface icons (e.g., buttons) for approving or rejecting the corrected image. The user of the conference room device selects one of the user interface icons, and an indication of the user's selection is transmitted to the server. If the user approves the corrected image, the server transmits the corrected image to the remote device (as described below at 810). If the user rejects the corrected image, the originally received image (of 802) is transmitted to the remote device in place of the corrected image.

At 810, the server transmits the corrected image to the remote device. The remote device displays the image as part of the video conference. At a later time, the conference room device may capture, via its camera, an additional image for the image feed. The additional image may be corrected by the image correction engine prior to transmission to the remote device in the video conference via the server.

FIG. 9 illustrates the technique 900 for conference room device configuration. The technique 900 may be performed by a setup server (e.g., the setup server 704) configured to communicate (e.g., over a network) with a conference room device (e.g., the conference room device 702) that is being configured.

At 902, the setup server receives an input indicating that the conference room device is to be configured. The input may be, for example, a message from the conference room device (or from a computing device of an operator) that the configuration of the conference room device is being initiated. The input may correspond to the configuration input 706.

At 904, the setup server accesses a representation of a signal received via the conference room device. The signal may be transmitted from the conference room device to the setup server in response to a request from the setup server. In one example, the signal is an image captured by the camera of the conference room device. In another example, the signal is an audio signal captured by the microphone of the conference room device, for example, while a sound is played via a speaker of the conference room device or while the operator makes an utterance. In yet another example, the signal includes both the audio signal and the image.

At 906, the setup server identifies a configuration of the conference room device based on the signal. For example, if the signal includes the image, the server may determine that the camera is improperly angled. If the signal includes the audio signal, the server may determine that the microphone is improperly (or sub-optimally) positioned for recording audio. This may be especially useful when the conference room device is intended to be used to transmit audio during a virtual concert.

At 908, the setup server determines an improvement to the configuration. For example, if the configuration includes the camera being improperly angled, the improvement may be adjusting the angle of the camera to make it proper. If the configuration includes the microphone being improperly positioned, the improvement may be repositioning the microphone for optimal audio recording based on the expected positions of human speakers (or musicians) and the expected wavelengths of the audio emitted by the human speakers (or the musicians and their musical instruments).

At 910, the setup server provides an output representing the determined improvement. The output may be transmitted to the conference room device and displayed on a display unit thereof for the operator to read and action. Alternatively, the output may be transmitted to the computing device or the messaging address of the operator. In another alternative, the conference room device may be capable of moving itself. For example, the conference room device may be capable of adjusting the angle of its camera and/or capable of moving the microphone or the speaker along a predetermined path. In this case, the output may be a control signal that causes the movement of the camera, the microphone, and/or the speaker to implement the determined improvement.

Some implementations are described below as numbered examples (Example 1, 2, 3, etc.). These examples are provided as examples only and do not limit the other implementations disclosed herein.

Example 1 is a method, comprising: receiving, at a server, an image from a video feed of a conference room device connected to a video conference; identifying, using an improvement detection engine at the server, a modification for the image; transmitting the modification to an image correction engine configured to generate a corrected image based on the modification; receiving the corrected image from the image correction engine; and transmitting the corrected image to a remote device for display.

In Example 2, the subject matter of Example 1 includes, wherein the modification comprises at least one of straightening the image, modifying a brightness level of the image, or placing a digital annotation to obscure a part of the image.

In Example 3, the subject matter of Examples 1-2 includes, wherein the image correction engine resides at the conference room device, wherein at least one of the improvement detection engine or the image correction engine comprises an artificial neural network.

In Example 4, the subject matter of Examples 1-3 includes, receiving an additional image associated with the video feed, the additional image being corrected by the image correction engine based on the modification; and transmitting the additional image to the remote device for display.

In Example 5, the subject matter of Examples 1-4 includes, transmitting, to the conference room device, a prompt for approval of the corrected image, wherein transmitting the corrected image to the remote device is in response to receiving the approval.

In Example 6, the subject matter of Examples 1-5 includes, transmitting, to an address associated with an administrator of the conference room device, a message comprising a representation of the modification.

In Example 7, the subject matter of Examples 1-6 includes, wherein the modification comprises an instruction for the image correction engine.

Example 8 is a non-transitory computer readable medium storing instructions operable to cause one or more processors to perform operations comprising: receiving, at a server, an image from a video feed of a conference room device connected to a video conference; identifying, using an improvement detection engine at the server, a modification for the image; transmitting the modification to an image correction engine configured to generate a corrected image based on the modification; receiving the corrected image from the image correction engine; and transmitting the corrected image to a remote device for display.

In Example 9, the subject matter of Example 8 includes, wherein the modification comprises at least one of straightening the image or modifying a brightness level of the image.

In Example 10, the subject matter of Examples 8-9 includes, wherein the image correction engine resides at the conference room device, wherein at least one of the improvement detection engine or the image correction engine comprises a convolutional neural network.

In Example 11, the subject matter of Examples 8-10 includes, the operations comprising: receiving an additional image associated with the video feed, the additional image being corrected by the image correction engine based on the modification; and transmitting the additional image to the remote device.

In Example 12, the subject matter of Examples 8-11 includes, the operations comprising: transmitting, to the conference room device, a prompt for approval of the corrected image; and receiving, from the conference room device, the approval in response to the prompt, wherein transmitting the corrected image to the remote device is in response to receiving the approval.

In Example 13, the subject matter of Examples 8-12 includes, the operations comprising: transmitting, to a device associated with an administrator of the conference room device, a message comprising a representation of the modification.

In Example 14, the subject matter of Examples 8-13 includes, wherein the modification comprises at least one instruction for the image correction engine.

Example 15 is an apparatus comprising: a memory; and a processor configured to execute instructions stored in the memory to: receive, at a server, an image from a video feed of a conference room device connected to a video conference; identify, using an improvement detection engine at the server, a modification for the image; transmit the modification to an image correction engine configured to generate a corrected image based on the modification; receive the corrected image from the image correction engine; and transmit the corrected image to a remote device for display.

In Example 16, the subject matter of Example 15 includes, wherein the modification comprises placing a digital annotation to obscure a part of the image.

In Example 17, the subject matter of Examples 15-16 includes, wherein the image correction engine resides at the conference room device.

In Example 18, the subject matter of Examples 15-17 includes, the processor being configured to execute the instructions stored in the memory to: receiving an additional image associated with the video feed, the additional image being corrected by the image correction engine; and transmitting the additional image to the remote device for display.

In Example 19, the subject matter of Examples 15-18 includes, the processor being configured to execute the instructions stored in the memory to: transmitting, to the conference room device, a prompt for approval of the corrected image.

In Example 20, the subject matter of Examples 15-19 includes, the processor being configured to execute the instructions stored in the memory to: transmit, to a predetermined messaging address, a message comprising a representation of the modification.

Example 21 is a method, comprising: receiving an input indicating that a conference room device comprising at least one of: a camera, a speaker or a microphone is to be configured; accessing a representation of a signal received via the conference room device; identifying a configuration of the conference room device based on the signal; determining an improvement to the configuration; and providing an output representing the determined improvement.

In Example 22, the subject matter of Example 21 includes, wherein accessing the representation of the signal comprises: causing the conference room device to capture an image via the camera.

In Example 23, the subject matter of Examples 21-22 includes, wherein accessing the representation of the signal comprises: causing the conferencing room device to output an audio signal via the speaker and to receive the audio signal via the microphone.

Example 24 is at least one machine-readable medium including instructions that, when executed by processing circuitry, cause the processing circuitry to perform operations to implement of any of Examples 1-23.

Example 25 is an apparatus comprising means to implement of any of Examples 1-23.

Example 26 is a system to implement of any of Examples 1-23.

Example 27 is a method to implement of any of Examples 1-23.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, at a server, an image from a video feed of a conference room device connected to a video conference;
identifying, using an improvement detection engine at the server, a modification for the image;
transmitting the modification to an image correction engine configured to generate a corrected image based on the modification;
receiving the corrected image from the image correction engine; and
transmitting the corrected image to a remote device for display.

2. The method of claim 1, wherein the modification comprises at least one of straightening the image, modifying a brightness level of the image, or placing a digital annotation to obscure a part of the image.

3. The method of claim 1, wherein the image correction engine resides at the conference room device, wherein at least one of the improvement detection engine or the image correction engine comprises an artificial neural network.

4. The method of claim 1, comprising:
receiving an additional image associated with the video feed, the additional image being corrected by the image correction engine based on the modification; and
transmitting the corrected additional image to the remote device for display.

5. The method of claim 1, comprising:
transmitting, to the conference room device, a prompt for approval of the corrected image, wherein transmitting the corrected image to the remote device is in response to receiving the approval.

6. The method of claim 1, comprising:
transmitting, to an address associated with an administrator of the conference room device, a message comprising a representation of the modification.

7. The method of claim 1, wherein the modification comprises an instruction for the image correction engine.

8. A non-transitory computer readable medium storing instructions operable to cause one or more processors to perform operations comprising:
receiving, at a server, an image from a video feed of a conference room device connected to a video conference;
identifying, using an improvement detection engine at the server, a modification for the image;
transmitting the modification to an image correction engine configured to generate a corrected image based on the modification;
receiving the corrected image from the image correction engine; and
transmitting the corrected image to a remote device for display.

9. The computer readable medium of claim 8, wherein the modification comprises at least one of straightening the image or modifying a brightness level of the image.

10. The computer readable medium of claim 8, wherein the image correction engine resides at the conference room device, wherein at least one of the improvement detection engine or the image correction engine comprises a convolutional neural network.

11. The computer readable medium of claim 8, the operations comprising:
receiving an additional image associated with the video feed, the additional image being corrected by the image correction engine based on the modification; and
transmitting the additional image to the remote device.

12. The computer readable medium of claim 8, the operations comprising:
transmitting, to the conference room device, a prompt for approval of the corrected image; and
receiving, from the conference room device, the approval in response to the prompt, wherein transmitting the corrected image to the remote device is in response to receiving the approval.

13. The computer readable medium of claim 8, the operations comprising:
transmitting, to a device associated with an administrator of the conference room device, a message comprising a representation of the modification.

14. The computer readable medium of claim 8, wherein the modification comprises at least one instruction for the image correction engine.

15. An apparatus comprising:
a memory; and
a processor configured to execute instructions stored in the memory to:
receive, at a server, an image from a video feed of a conference room device connected to a video conference;
identify, using an improvement detection engine at the server, a modification for the image;
transmit the modification to an image correction engine configured to generate a corrected image based on the modification;
receive the corrected image from the image correction engine; and
transmit the corrected image to a remote device for display.

16. The apparatus of claim 15, wherein the modification comprises placing a digital annotation to obscure a part of the image.

17. The apparatus of claim 15, wherein the image correction engine resides at the conference room device.

18. The apparatus of claim 15, the processor being configured to execute the instructions stored in the memory to:
receiving an additional image associated with the video feed, the additional image being corrected by the image correction engine; and
transmitting the additional image to the remote device for display.

19. The apparatus of claim 15, the processor being configured to execute the instructions stored in the memory to:
transmitting, to the conference room device, a prompt for approval of the corrected image.

20. The apparatus of claim 15, the processor being configured to execute the instructions stored in the memory to:
transmit, to a predetermined messaging address, a message comprising a representation of the modification.
